(19) United States
(12) Patent Application Publication
(10) Pub. No.: US 2020/0257749 A1
(43) Pub. Date: Aug. 13, 2020

(54) METHOD AND A DEVICE FOR FRIEND RECOMMENDATION

(71) Applicant: SHANGHAI ZHANGMEN SCIENCE AND TECHNOLOGY CO., LTD., SHANGHAI (CN)

(72) Inventor: Sinan LI, Shanghai (CN)

(21) Appl. No.: 16/862,595

(22) Filed: Apr. 30, 2020

Related U.S. Application Data
(63) Continuation of application No. PCT/CN2018/104359, filed on Sep. 6, 2018.

(30) Foreign Application Priority Data
Nov. 1, 2017 (CN) 201711059142.5

(51) Int. Cl. G06F 16/9535; H04L 12/58; G06F 16/9538

(52) U.S. Cl. CPC G06F 16/9535; G06F 16/9538; H04L 51/32

(57) ABSTRACT

An objective of the present application is to provide a method and a device for friend recommendation. The present application implements reverse friend recommendation according to a contact list by the following steps: obtaining user information of a first user and indication information of a second user; determining the second user according to the indication information of the second user; sending the user information of the first user to a recommended user list of the second user. Further, information on a contact list of the first user is compared with information on a friend list of the first user, and a contact not in the friend list but in the contact list is identified as the second user, so that recommending friends repeatedly which causes a waste of system resources is avoided.

### CROSS REFERENCE TO THE RELATED APPLICATION

This application is the continuation application of International Application No. PCT/CN2018/104359, filed on Sep. 6, 2018, which is based upon and claims priority to Chinese Patent Application No. 201711059142.5, filed on Nov. 1, 2017, the entire contents of which are incorporated herein by reference.

### FIELD

The present application relates to computers, and more specifically relates to a method and a device for friend recommendation.

### BACKGROUND

With the development of network technology, people begin to use more and more social applications to communicate with others, so that users can communicate with friends via the social applications at anytime from anywhere. In practical applications, a user needs to register before using social applications. After registering, a recommendation system will recommend contacts who have registered the application and are in a contact list of the user as friends to the user. Such method for friend recommendation only comes from a contact list of a user in one way. Some users have fewer contacts saved in their mobile phones due to their mobile phones being replaced frequently or their personal habits. Thus, it is difficult to recommend more friends to the users quickly, reducing user viscosity of social applications.

### SUMMARY

An objective of the present application is to provide a method and a device for friend recommendation, which realizes reverse friend recommendation according to a contact list, recommends more friends to users, and increases user viscosity of social applications.

According to an aspect of the present application, it is provided a method for friend recommendation at a network device. The method comprises:

obtaining user information of a first user and second user indication information;

determining a second user according to the second user indication information; and

sending the user information of the first user to a recommended user list of the second user.

Further, in above mentioned method, the second user indication information comprises second user identification information, and determining the second user according to the second user indication information comprises:

determining the second user according to the second user identification information.

Further, the second user identification information is determined by:

comparing, by a first user equipment, information on a contact list of the first user with information on a friend list of the first user and determining identification information of a contact not in the friend list but in the contact list as the second user identification information.

Further, the second user indication information comprises information on a contact list of the first user, and determining the second user according to the second user indication information comprises:

determining the second user according to the information on the contact list of the first user.

Further, in above mentioned method, determining the second user according to the information on the contact list of the first user comprises:

obtaining information on a friend list of the first user; and

comparing the information on the contact list of the first user with the information on the friend list of the first user, and determining a contact not in the friend list but in the contact list as the second user.

Further, in above mentioned method, sending the user information of the first user to the recommended user list of the second user comprises:

obtaining information on a friend list of the second user, determining whether the first user is existing in the friend list of the second user, and if not, sending the user information of the first user to the recommended user list of the second user.

Further, in the above mentioned method, the method comprises:

obtaining a record of historic communication between the first user and the second user;

determining an intimacy value between the first user and the second user based on the record of the historical communication, and the record of the historical communication comprises at least one of: frequency of calls, duration of calls, and frequency of messaging;

and

sending the user information of the first user and the intimacy value between the first user and the second user to the recommended user list of the second user;

or,

obtaining an intimacy value between the first user and the second user from a first user equipment where the first user is located, and the intimacy value is determined by the first user equipment according to the record of the historical communication between the first user and the second user; and

sending the user information of the first user and the intimacy value between the first user and the second user to the recommended user list of the second user.

Further, in the above mentioned method, the method also comprises:

obtaining a blacklist of the second user; and

determining whether the first user is in the blacklist of the second user, and if so, refusing to send the information of the first user to the recommended user list of the second user.

Further, in above mentioned method, sending the user information of the first user to the recommended user list of the second user comprises:

determining the first user to be recommended according to an obtained history record that the second user did not agree to add a new friend and/or marking information on the first user by other users; and

sending the user information of the first user to be recommended to the recommended user list of the second user.

According to a further aspect of the present application, it is also provided a method for friend recommendation at a first user equipment. The method comprises:

providing user information of a first user and second user indication information to a network device, and the second user indication information is used by the network device to determine a second user, and sending, by the network device, the user information of the first user to a recommended user list of the second user; and

receiving a new friend request sent by the second user to the first user, and the new friend request sent by the second user to the first user is triggered by the second user selecting the first user in the recommended user list of the second user.

Further, the second user indication information comprises second user identification information, and the network device determines the second user according to the second user identification information, and the second user identification information is obtained by: comparing, by the first user equipment, information on a contact list of the first user with information on a friend list of the first user and determining identification information of a contact not in the friend list but in the contact list as the second user identification information.

Further, the second user indication information comprises information on a contact list of the first user, and the network device compares the information on the contact list of the first user with information on a friend list of the first user, and identifies a contact not in the friend list but in the contact list as the second user.

Further, the method comprises:

sending a record of historical communication with the second user to the network device, and the network device determines an intimacy value between the first user and the second user according to the record of the historical communication, and sends the intimacy value between the first user and the second user to the recommended user list of the second user, and the record of the historical communication comprises at least one of: frequency of calls, duration of calls, and frequency of messaging; or,

determining an intimacy value between the first user and the second user according to the record of the historical communication with the second user, and the network device sends the intimacy value between the first user and the second user to the recommended user list of the second user, and the record of the historical communication comprises at least one of: frequency of calls, duration of calls, and frequency of messaging.

According to a further aspect of the present application, it is also provided a method for friend recommendation at a second user equipment. The method comprises: receiving user information of a first user in a recommended user list sent by a network device, and the first user is determined, by the network device, according to information on a contact list of the first user and one of: information on a friend list of the first user, information on a friend list of a second user; and

sending a new friend request to the first user in the recommended user list.

According to yet another aspect of the present application, it is also provided a method for friend recommendation. The method comprises:

providing, by a first user equipment, user information of a first user and second user indication information to a network device;

determining, by the network device, a second user according to the second user indication information, and sending the user information of the first user to a recommended user list of the second user; and

sending, by the second user, a new friend request to the first user in the recommended user list.

According to another aspect of the present application, it is provided a computer readable medium having computer readable instructions stored thereon, the computer readable instructions being executable by a processor to implement the above mentioned methods.

According to yet another aspect of the present application, it is also provided a network device for friend recommendation. The network device comprises:

one or more processors; and

a memory storing computer readable instructions, and the computer readable instructions, when executed, cause the processor to perform the operations of the method for friend recommendation at a network device as mentioned above.

According to a further aspect of the present application, it is also provided a first user equipment for friend recommendation. The first user equipment comprises: one or more processors; and a memory storing computer readable instructions, and the computer readable instructions, when executed, cause the processor to perform the operations of the method for friend recommendation at a first user equipment as mentioned above.

According to a further aspect of the present application, it is also provided a second user equipment for friend recommendation. The second user equipment comprises:

one or more processors; and

a memory storing computer readable instructions, and the computer readable instructions, when executed, cause the processor to perform the operations of the method for friend recommendation at a second user equipment as mentioned above.

Compared with the prior art, the present application implements reverse friend recommendation according to a contact list by the following steps: obtaining user information of a first user and second user indication information; determining a second user according to the second user indication information; sending the user information of the first user to a recommended user list of the second user. Further, after obtaining information on the friend list of the first user, information on the contact list of the first user is compared with the information on the friend list of the first user, and a contact not in the friend list but in the contact list is identified as the second user, so that recommending friends repeatedly which causes a waste of system resources is avoided.

### DESCRIPTIONS OF THE DRAWINGS

Embodiments of the present application will become more apparent by reading the detailed description of non-limiting embodiments with reference to the following drawings:

FIG. 1 shows a schematic flowchart of a method for friend recommendation provided according to one aspect of the present application;

FIG. 2 shows a schematic flowchart for friend recommendation provided according to another aspect of the present application.

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (CPUs), an input/output interface, a network interface and a memory.

The memory may include a non-permanent memory, a random access memory (RAM) and/or a non-volatile memory and the like in a computer-readable medium, such as a read-only memory (ROM) or a flash memory (flash RAM)). A memory is an example of a computer-readable medium.

A computer-readable medium comprises permanent and non-permanent, movable and non-movable media and may implement information storage by means of any method or technology. Information may be computer-readable instructions, data structures, program modules or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission media, which can be used to store information that can be accessed by a computing device. According to the definition herein, the computer-readable medium does not include a non-transitory computer-readable medium, such as a modulated data signal and a carrier.

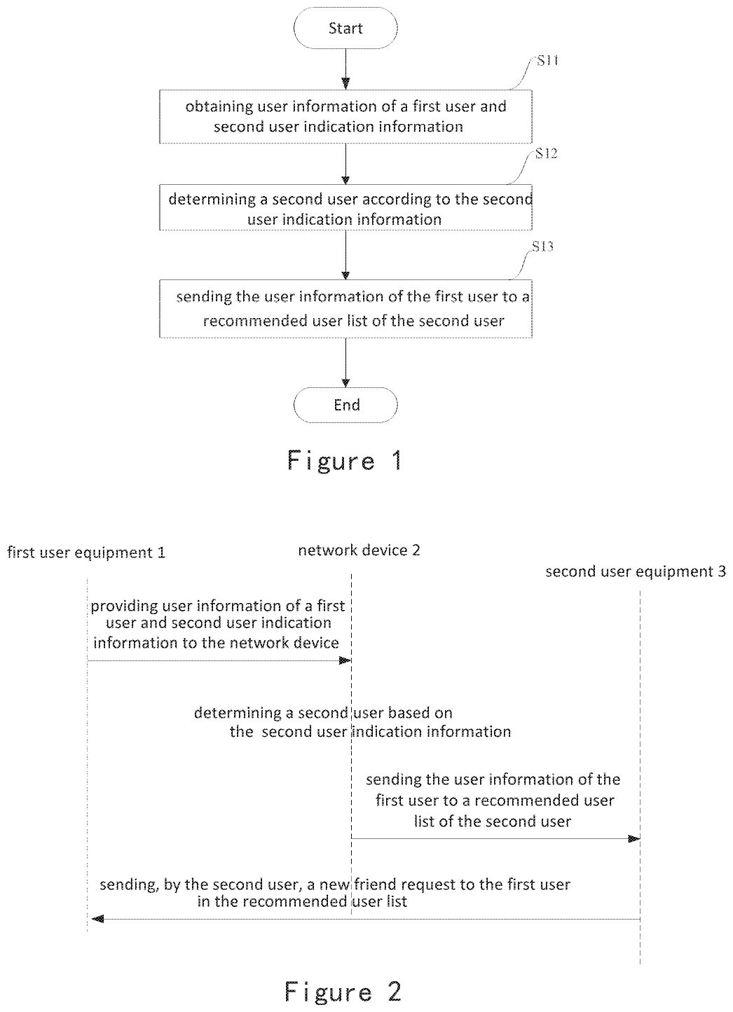

FIG. 1 shows a schematic flowchart of a method for friend recommendation at a network device provided according to an aspect of the present application. The method comprises steps S11 to S13. At step S11, user information of a first user and second user indication information are obtained. At step S12, a second user is determined according to the second user indication information. At step S13, the user information of the first user is sent to a recommended user list of the second user. Here, the first user and the second user are relative to each other. A user whose contact list contains other user(s) may be identified as a first user, and it is determined whether the other user(s) contained in the contact list can be identified as the second user according to indication information of the other user(s) contained in the contact list. For example, if contacts in a contact list of a user A contain a user B, user A is a first user, and it is determined whether user B is a second user according to indication information of user B. Then, when user B is the second user, user information of user A is recommended to user B, and thus the user information of user A is contained in a recommended user list of user B, which realizes reverse friend recommendation according to the contact list. The user information comprises information for identifying a user identity, such as a user name, a mobile phone number or the like. It should be noted that the network device described in the foregoing embodiment may be a server, or multiple servers connected through a local area network or multiple servers connected through the Internet, or a cloud composed of multiple servers. Here, the cloud is composed of a massive number of computers or network servers based on Cloud Computing, and cloud computing is a type of distributed computing, which is a super virtual computer composed of a group of loosely coupled computer sets.

In an embodiment of the present application, when the second user indication information comprises second user identification information. The network device may obtain identification information of a second user in the contact list which has been filtered by a first user equipment where a first user is located, and determine the second user according to the second user identification information. Here, in specific, filtering contacts in the contact list of the first user and determining the second user identification information may be determined by: comparing, by the first user equipment, information on the contact list of the first user with information on a friend list of the first user and determining identification information of a contact not in the friend list but in the contact list as the second user identification information. Comparison is conducted at the first user equipment at first, and then the network device receives the identification information of the second user determined by the comparison, and to send recommendation information for recommending a friend desired by the second user to the second user who has been determined according to the identification information, which can avoid distributing friend recommendation messages arbitrarily and can reduce the amount of data required by data transmission when reporting to the network device, saving network traffic, and thus reducing burden on the network device.

In addition, the network device not only can obtain the identification information of the second user which has been filtered by the first user equipment where the first user is located at first, to determine the second user, but also can obtain information on a contact list sent by the first user, to filter and determine the second user. When the second user indication information comprises information on a contact list of the first user, the second user may be determined according to the information on the contact list of the first user. In specific, information on a friend list of the first user is obtained, the information on the contact list of the first user is compared with the information on the friend list of the first user, and a contact not in the friend list but in the contact list is identified as the second user. Here, when each of contacts in the contact list of the first user is identified as the second user, it will cause invalid recommendation and a waste of system resources. For example, if user B and user C contained in the contact list of the first user (user A) are already existing in a friend list of user A, there is no need to recommend user information of user A to user B and user C. Therefore, the contacts in the contact list of user A may be compared with friends in the friend list of user A at first. When some user(s) are only existing in the contact list of user A but not existing in the friend list of user A, such user(s) may be identified as the second user(s), and to recommend user A to the contacts in the contact list who have not established friend relationship with user A.

In an embodiment of the present application, at step S12, information on a friend list of the second user is obtained, and it is determined whether the first user is existing in the friend list of the second user. If not, the user information of the first user is sent to a recommended user list of the second user. Here, when a contact list of the first user contains contact information of the second user, and thus the first user is recommended to the second user, the first user may already be existing in a friend list of the second user. At this time, there is no need to recommend the first user to the second user repeatedly. Therefore, it may be determined whether the first user is already existing in the friend list according to the information on the friend list of the second user. If not, then the user information of the first user is sent to a recommended user list of the second user, and to achieve reverse friend recommendation according to the contact list.

In an embodiment of the present application, the method comprises step S14, in which: a record of historic communication between the first user and the second user is obtained; and an intimacy value between the first user and the second user is determined based on the record of the historical communication, and the record of the historical communication comprises at least one of: frequency of calls, duration of calls, and frequency of messaging; or an intimacy value between the first user and the second user is obtained from a first user equipment where the first user is located, and the intimacy value is determined by the first user equipment according to the record of the historical communication between the first user and the second user. Here, a record of historical communication between the first user and the second user may be obtained at first. The record of historical communication may be frequency of calls, such as number of calls within a month, duration of calls, such as total duration of calls or duration of each call, frequency of messaging, such as total number of messages sent within a month, etc. Intimacy between the first user and the second user may be calculated according to communication features in the record of the historical communication and corresponding weights thereof, and to provide better friend recommendation. An intimacy value which has been determined may also be obtained from a first user equipment directly, and the intimacy value is calculated by the first user equipment according to the record of the historical communication between the first user and the second user. Then, after the intimacy is calculated, the user information of the first user and the intimacy value between the first user and the second user may be sent to a recommended user list of the second user. For example, intimacy between user A and user B is 50, and intimacy between user C and user B is 80. In the recommended user list of user B, each recommended user is sorted according to the intimacy, and the corresponding intimacy is displayed, and the user B selects a recommended user more intuitively and sends a new friend request, and thus relevance and effectiveness of friend recommendation are enhanced.

In an embodiment of the present application, the method further comprises step S15, in which: a blacklist of the second user is obtained; and it is determined whether the first user is in the blacklist of the second user, and if so, sending the information of the first user to the recommended user list of the second user is rejected. Of course, in case where the first user is recommended to the second user as long as a contact list of the first user contains contact information of the second user, the second user may not intend to establish friend relationship with the first user, may not be interested in the first user, or may have deleted the first user or set the first user in a blacklist in history. Also, the first user may obtain the contact information of the second user in other ways. At this time, if the first user is recommended to the second user as long as the contact list of the first user contains the second user, it will cause disturbance to the second user, and degrade user experience. Therefore, the blacklist of the second user may be obtained at first, and then it is determined whether the first user is in the blacklist. If so, the first user is no longer recommended to the second user.

In an embodiment of the present application, when a first user is recommended to a second user, the first user to be recommended may also be determined according to an obtained history record that the second user did not agree to add a new friend and/or marking information on the first user by other users. The user information of the first user to be recommended is sent to a recommended user list of the second user. Here, in practical scenarios, some intermediary agents or other harassers may obtain contact information of the user in some ways, and the user does not want to be disturbed by these people. If these people are also recommended to the user, user experience will be degraded. Therefore, a record of the second user's historical behaviors regarding adding a new friend may be obtained, for example, information of users who have been rejected, or marking information on the first user by other users, such as an intermediary agent as marked or the like, then these people should be removed when providing friend recommendation to the second user. That is, the first user to be recommended is determined according to an obtained history record that the second user did not agree to add a new friend and/or marking information on the first user by other users. The first user to be recommended does not comprise a user that the second user refused to add as friend in history, and/or a user marked by other users as a harassing user, such as an intermediary agent, an advertisement promoter, or the like.

According to a further aspect of the present application, it is also provided a method for friend recommendation at a first user equipment. The method comprises: step S21 and step S22.

At step S21, user information of a first user and second user indication information are provided to a network device, and the second user indication information is used by the network device to determine a second user, and the network device sends the user information of the first user to a recommended user list of the second user. Here, a user uploads his/her own user information and information on his/her contact list, so that the network device determines contacts in the contact list who correspond to the uploading user according to the received information. A user whose contact list contains other user(s) may be identified as a first user, and it is determined whether the other user(s) contained in the contact list can be identified as a second user according to indication information of the other user(s). For example, if contacts in a contact list of user A contain user B, user A is a first user, and it is determined whether user B is a second user according to indication information of user B.

At step S22, a new friend request sent by the second user to the first user is received, and the new friend request sent by the second user to the first user is triggered by the second user selecting the first user in the recommended user list of the second user. After the network device determines the second user who corresponds to the first user, user information of the first user is sent to the second user. A new friend request event is triggered when the second user selects the first user in the recommended user list of the second user. The first user receives the new friend request from the second user, and establishes friend relationship with the second user upon approval of the new friend request.

It should be noted that, the first user equipment includes but is not limited to mobile electronic products capable of human-machine interaction with users via touchpads, for example, an intelligent phone, a PDA, etc. The mobile electronic products can run on any operating system, such as android operating system, iOS operating system, etc.

In an embodiment of the present application, the second user may be filtered at the first user equipment. The second user indication information comprises second user identification information, and a network device determines a second user according to the second user identification information. In specific, filtering contacts in the contact list of the first user and determining the second user identification information is obtained by: comparing, the first user equipment, information on a contact list of the first user with information on a friend list of the first user and determining identification information of a contact not in the friend list but in the contact list as the second user identification information. Comparison is conducted at the first user equipment at first, and then the network device receives the identification information of the second user determined by the comparison, and to send recommendation information for recommending a friend desired by the second user to the second user who has been determined according to the identification information, which can avoid distributing friend recommendation messages arbitrarily and can reduce the amount of data required by data transmission when reporting to the network device, saving network traffic, and thus reducing burden on the network device.

In an embodiment of the present application, when the second user indication information comprises information on a contact list of the first user, the network device may compare the information on the contact list of the first user with information on a friend list of the first user, and determining a contact not in the friend list but in the contact list as the second user. Here, when each of the contacts in the contact list of the first user is identified as the second user, it will cause invalid recommendation and a waste of system resources. Therefore, the information on the friend list of the first user may be uploaded to a network device, and thus one or more contacts in the contact list who have not established friend relationship with the first user are determined. The user information of the second user determined through the comparison is sent to the network device, and the network device recommends the first user to the second user.

In an embodiment of the present application, the method comprises step S23, in which: a record of historical communication with the second user is sent to the network device, and the network device determines an intimacy value between the first user and the second user according to the record of the historical communication, and sends the intimacy value between the first user and the second user to the recommended user list of the second user, and the record of the historical communication comprises at least one of: frequency of calls, duration of calls, and frequency of messaging. Here, the record of historical communication of a contact list of the first user may be sent to the network device at first, and then the network device calculates an intimacy value between the first user and the second user. Of course, an intimacy value between the first user and the second user may also be determined according to the record of the historical communication with the second user, and the network device sends the intimacy value between the first user and the second user to the recommended user list of the second user, and the record of the historical communication comprises at least one of: frequency of calls, duration of calls, and frequency of messaging. The intimacy value between the first user and the second user is sent to the network device. Here, the intimacy value between the first user and the second user may be calculated through the record of the historical communication of the contact list of the first user. Then the calculated intimacy value is sent to the network device, and the network device sends the intimacy value between the first user and the second user to the recommended user list of the second user. The intimacy value is calculated at the first user equipment at first, and then sent to the second user equipment through the network device, which can reduce the amount of data required by data transmission when reporting to the network device, saving network traffic, and thus reducing calculation burden on the network device.

According to a further aspect of the present application, it is also provided a method for friend recommendation at a second user equipment. The method comprises: step S31 and step S32.

At step S31, user information of a first user in a recommended user list sent by a network device is received, and the first user is determined, by the network device, according to information on a contact list of the first user and one of: information on a friend list of the first user, information on a friend list of a second user. Here, the first user is filtered and determined by the network device according to the contacts in the contact list and one of: information on a friend list of the first user, information on a friend list of a second user. For example, user B receives user information of the recommended user (user A), and thus the user information of user A is contained in a recommended user list of user B. User A is determined, by the network device, according to information on a contact list of user A as well as information on a friend list of user A or information on a friend list of user B. For example, if contacts in the contact list of user A contain user B, and there is no user B exists in the friend list of user A, or there is no user A exists in the friend list of user B, user A is a first user relative to user B and user B is a second user relative to user A at this time. Thus, reverse friend recommendation according to the contact list can be implemented by recommending user A to user B. The user information comprises information for identifying a user identity, such as a user name, a mobile phone number or the like.

At step S32, a new friend request is sent to the first user in the recommended user list, and friend relationship is established with the first user after receiving a notification sent by the first user indicating that the new friend request has been approved. Here, the second user sends a new friend request to the selected first user in the recommended user list based on the recommended user list. After the first user approved the new friend request, the second user establishes friend relationship with the first user. Thus, relevance and effectiveness of friend recommendation are enhanced by way of reverse friend recommendation according to the contact list, and the effect of expanding network of friend relationship quickly is achieved.

It should be noted that, the second user equipment includes but is not limited to mobile electronic products capable of human-machine interaction with users via touchpads, for example, an intelligent phone, a PDA, etc. The mobile electronic products can run on any operating system, such as android operating system, iOS operating system, etc.

FIG. 2 shows a schematic flowchart for friend recommendation provided according to another aspect of the present application. A first user equipment 1 provides user information of a first user and second user indication information to a network device 2. The network device 2 determines a second user based on the second user indication information, and sends the user information of the first user to a recommended user list of the second user. The second user on the second user equipment 3 sends a new friend request to the first user in the recommended user list.

Here, the first user equipment 1 uploads the user information of the first user and the indication information of the second user to the network device 2. The network device 2 determines the second user contained in a contact list based on uploaded indication information of the second user, and distributes the user information of the first user obtained from the first user equipment 1 to the second user equipment 3 where the second user is located. Thus, the recommended user list is determined according to the received user information of the first user on the second user equipment 3, one or more recommended users are selected from the recommended user list, and a new friend request is sent. After the other party agreed, friend relationship is established with the other party, realizing reverse friend recommendation according the contact list, and achieving effect of expanding network of friend relationship quickly.

In addition, according to another aspect of the present application, it is provided a computer readable medium having computer readable instructions stored thereon, the computer readable instructions being executable by a processor to implement the above mentioned method.

In an embodiment of the present application, according to yet another aspect of the present application, it is also provided a network device for friend recommendation. The network device comprises:

one or more processors; and

a memory storing computer readable instructions, and the computer readable instructions, when executed, cause the processor to perform the operations of the method for friend recommendation as mentioned above. For example, the computer readable instructions, when executed, cause the one or more processors to: obtain user information of a first user and second user indication information; determine a second user according to the second user indication information; send the user information of the first user to a recommended user list of the second user.

In an embodiment of the present application, according to a further aspect of the present application, it is also provided a first user equipment for friend recommendation. The first user equipment comprises:

one or more processors; and

a memory storing computer readable instructions, and the computer readable instructions, when executed, cause the processor to perform the operations of the method for friend recommendation at a first user equipment as mentioned above.

For example, the computer readable instructions, when executed, cause the one or more processors to: provide user information of a first user and second user indication information to a network device, and the second user indication information is used by the network device to determine a second user, and send, by the network device, the user information of the first user to a recommended user list of the second user; receive a new friend request sent by the second user to the first user, and the new friend request sent by the second user to the first user is triggered by the second user selecting the first user in the recommended user list of the second user.

In an embodiment of the present application, according to a further aspect of the present application, it is also provided a second user equipment for friend recommendation. The second user equipment comprises:

one or more processors; and

a memory storing computer readable instructions, and the computer readable instructions, when executed, cause the processor to perform the operations of the method for friend recommendation at a second user equipment as mentioned above.

For example, the computer readable instructions, when executed, cause the one or more processors to: receive user information of a first user in a recommended user list sent by a network device, and the first user is determined by the network device according to information on a contact list of the first user and one of: information on a friend list of the first user, information on a friend list of a second user; send a new friend request to the first user in the recommended user list.

In one embodiment, various modifications and variations to the present application can be made without departing the spirit and scope of the present application. In this way, if these modifications and variations of the present application fall within the scope of the claims of the present application and equivalent technologies thereof, the present application is also intended to encompass these modifications and variations.

It should be noted that the present application can be implemented in software and/or a combination of software and hardware, for example, by using an application specific integrated circuit (ASIC), a general purpose computer, or any other similar hardware device. In one embodiment, the software program of the present application can be executed by a processor to implement the steps or functions described above. Likewise, the software programs (including related data structures) of the present application can be stored in a computer readable storage medium such as a RAM memory, a magnetic or optical drive or a floppy disk and the like. In addition, some of the steps or functions of the present application may be implemented in hardware, for example, as a circuit that cooperates with a processor to perform various steps or functions.

In addition, a portion of the present application can be embodied as a computer program product, such as computer program instructions, when executed by a computer, can invoke or provide a method in accordance with the present application. The program instructions for invoking the method of the present application may be stored in a fixed or removable storage medium, and/or transmitted by a data stream in a broadcast or other signal carrier medium, and/or stored in a working memory of the computer device in which the program instructions run. Herein, an embodiment in accordance with the present application includes an apparatus including a memory for storing computer program instructions and a processor for executing program instructions, and when the computer program instructions are executed by the processor, triggering the apparatus to operate the above mentioned methods in accordance with various embodiments of the present application.

In one embodiment, it is apparent that the present application is not limited to the details of the above-mentioned exemplary embodiments, and the present application can be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. A plurality of units or means stated in the apparatus claims may also be implemented by one unit or means by means of software or hardware. The terms first and second and the like are used to represent names and do not represent any particular order.

What is claimed is:

1. A method for friend recommendation at a network device, comprising:
obtaining user information of a first user and second user indication information;
determining a second user according to the second user indication information; and
sending the user information of the first user to a recommended user list of the second user.

2. The method according to claim 1, wherein the second user indication information comprising second user identification information, and wherein the step of determining the second user according to the second user indication information, comprising:
determining the second user according to the second user identification information.

3. The method according to claim 2, wherein the second user identification information is determined by:
comparing, by a first user equipment, information on a contact list of the first user with information on a friend list of the first user and determining identification information of a contact not in the friend list but in the contact list as the second user identification information.

4. The method according to claim 1, wherein the second user indication information comprising information on a contact list of the first user, and wherein the step of determining the second user according to the second user indication information, comprising:
determining the second user according to the information on the contact list of the first user.

5. The method according to claim 4, wherein the step of determining the second user according to the information on the contact list of the first user, comprising:
obtaining information on a friend list of the first user; and
comparing the information on the contact list of the first user with the information on the friend list of the first user, and determining a contact not in the friend list but in the contact list as the second user.

6. The method according to claim 4, wherein the step of sending the user information of the first user to the recommended user list of the second user, comprising:
obtaining information on a friend list of the second user, determining whether the first user is existing in the friend list of the second user, and if not, sending the user information of the first user to the recommended user list of the second user.

7. The method according to claim 1, wherein the method further comprising:
obtaining a record of historic communication between the first user and the second user;
determining an intimacy value between the first user and the second user based on the record of the historical communication, wherein the record of the historical communication comprises at least one of: frequency of calls, duration of calls, and frequency of messaging; and
sending the user information of the first user and the intimacy value between the first user and the second user to the recommended user list of the second user;
or,
obtaining an intimacy value between the first user and the second user from a first user equipment where the first user is located, wherein the intimacy value is determined by the first user equipment according to the record of the historical communication between the first user and the second user; and
sending the user information of the first user and the intimacy value between the first user and the second user to the recommended user list of the second user.

8. The method according to claim 1, wherein the step of sending the user information of the first user to the recommended user list of the second user, comprising:
obtaining a blacklist of the second user; and
determining whether the first user is in the blacklist of the second user, and if so, terminating sending the user information of the first user to the recommended user list of the second user.

9. The method according to claim 1, wherein the step of sending the user information of the first user to the recommended user list of the second user, comprising:
determining the first user to be recommended according to an obtained history record that the second user did not agree to add a new friend and/or marking user information on the first user by other users; and
sending the user information of the first user to be recommended to the recommended user list of the second user.

10. A method for friend recommendation at a first user equipment, comprising:
providing user information of a first user and second user indication information to a network device, wherein the second user indication information is used by the network device to determine a second user, and sending, by the network device, the user information of the first user to a recommended user list of the second user; and
receiving a new friend request sent by the second user to the first user, wherein the new friend request sent by the second user to the first user is triggered by the second user selecting the first user in the recommended user list of the second user.

11. The method according to claim 10, wherein the second user indication information comprising second user identification information, and the network device determines the second user according to the second user identification information, wherein the second user identification information is obtained by: comparing, by the first user equipment, information on a contact list of the first user with information on a friend list of the first user and determining identification information of a contact not in the friend list but in the contact list as the second user identification information.

12. The method of claim 10, wherein the second user indication information comprising information on a contact list of the first user, and the network device compares the information on the contact list of the first user with information on a friend list of the first user, and identifies a contact not in the friend list but in the contact list as the second user.

13. The method according to claim 8, wherein the method further comprising:
sending a record of historical communication with the second user to the network device, and the network device determines an intimacy value between the first user and the second user according to the record of the historical communication, and sends the intimacy value between the first user and the second user to the recommended user list of the second user, wherein the record of the historical communication comprises at least one of: frequency of calls, duration of calls, and frequency of messaging; or,
determining an intimacy value between the first user and the second user according to a record of the historical communication with the second user, and the network device sends the intimacy value between the first user and the second user to the recommended user list of the second user, wherein the record of the historical communication comprises at least one of: frequency of calls, duration of calls, and frequency of messaging.

14. A network device for friend recommendation, comprising:
one or more processors; and
a memory storing computer readable instructions, wherein the computer readable instructions, when executed, cause the processor to:
obtain user information of a first user and second user indication information;
determine a second user according to the second user indication information; and
send the user information of the first user to a recommended user list of the second user.
